(19) United States
(12) Patent Application Publication
(10) Pub. No.: US 2010/0223126 A1
(43) Pub. Date: Sep. 2, 2010

(54) ADVERTISING SYSTEM AND METHOD

(76) Inventors: KEVIN W. TUNG, New York, NY (US); Raymond Eng Chan, New York, NY (US)

Correspondence Address: HOLLAND & KNIGHT LLP, 10 ST. JAMES AVENUE, BOSTON, MA, 02116-3889, US

(21) Appl. No.: 12/716,116

(22) Filed: Mar. 2, 2010

Related U.S. Application Data
(60) Provisional application No. 61/156,626, filed on Mar. 2, 2009.

(51) Int. Cl. G06Q 30/00; G06F 3/14

(52) U.S. Cl. 705/14.49; 715/234

(57) ABSTRACT

A system, computer-implemented method, and a computer program product for processing one or more webpage images included within a webpage to identify one or more advertisement-compatible target images. An advertisement-compatible target image, chosen from the one or more advertisement-compatible target images, is analyzed to associate the advertisement-compatible target image with one or more advertisement categories. An advertisement overlay is generated for the advertisement-compatible target image. The advertisement overlay is associated with at least one of the one or more advertisement categories. The webpage is modified to render the advertisement overlay on top of the advertisement-compatible target image.

### RELATED APPLICATION

This application claims the benefit of U.S. Provisional Application Ser. No. 61/156,626, filed on 2 Mar. 2009, which is herein incorporated by reference in its entirety.

### TECHNICAL FIELD

This disclosure relates to advertising and, more particularly, to image-based advertising.

### BACKGROUND

As the internet continues to evolve, publishers continue to develop ways to monetize their content. Like with more-traditional forms of media, a large portion of revenue generated on the internet is based upon advertising dollars. Further, due to the bidirectional nature of the internet, advertisers are able to monitor the manner in which people respond to their advertisements. For example, the number of times that a user clicks on an advertisement included within a webpage may be monitored to determined the traffic that a specific advertisement is generating. Further, the results of such visits may be monitored to determine how often a person that visits the advertisers site actually makes a purchase.

While systems exist that allow a publisher to manually associate an image with an advertisement, such manual systems are time consuming and require persistent maintenance to associate newly-added images with advertisements.

### SUMMARY OF DISCLOSURE

In a first implementation, a computer-implemented method includes processing one or more webpage images included within a webpage to identify one or more advertisement-compatible target images. An advertisement-compatible target image, chosen from the one or more advertisement-compatible target images, is analyzed to associate the advertisement-compatible target image with one or more advertisement categories. An advertisement overlay is generated for the advertisement-compatible target image. The advertisement overlay is associated with at least one of the one or more advertisement categories. The webpage is modified to render the advertisement overlay on top of the advertisement-compatible target image.

One or more of the following features may be included. Modifying the webpage may include modifying the webpage to render the advertisement overlay on top of the advertisement-compatible target image in response to activity by a user of the webpage. Processing one or more webpage images may include excluding from the one or more advertisement-compatible target images those webpage images that have a image size that is smaller than a defined minimum image size; and excluding from the one or more advertisement-compatible target images those webpage images that have an image size that is equal to a standard advertisement image size.

Analyzing an advertisement-compatible target image may include one or more of the following: extracting page-specific metadata from code associated with the webpage; extracting image-specific metadata from code associated with the advertisement-compatible target image; extracting image-specific metadata from a filename associated with the advertisement-compatible target image; and extracting user specific metadata associated with the user of the webpage. Analyzing an advertisement-compatible target image may include assigning one or more weighting scores to the advertisement-compatible target image, wherein each of the one or more weighting scores defines a level of association with each of the one or more advertisement categories.

Generating an advertisement overlay for the advertisement-compatible target image may include one or more of the following: defining an overlay type, wherein the advertisement overlay is generated in accordance with the defined overlay type; defining an overlay size; and defining an overlay position. The overlay type may be chosen from the group consisting of: a text only overlay; an image/banner overlay; a text and image overlay; a video overlay; an audio overlay; an audio/video overlay; a rich media interactive overlay; and a search overlay.

A publisher of the webpage may be provided with a revenue payment each time that an action is taken by the user of the webpage. The action taken by the user of the webpage may be chosen from the group consisting of: an automatic rendering action; a mouse over action; a clicking through action; and a product purchase.

In another implementation, a computer program product resides on a computer readable medium having a plurality of instructions stored on it. When executed by a processor, the instructions cause the processor to perform operations including processing one or more webpage images included within a webpage to identify one or more advertisement-compatible target images. An advertisement-compatible target image, chosen from the one or more advertisement-compatible target images, is analyzed to associate the advertisement-compatible target image with one or more advertisement categories. An advertisement overlay is generated for the advertisement-compatible target image. The advertisement overlay is associated with at least one of the one or more advertisement categories. The webpage is modified to render the advertisement overlay on top of the advertisement-compatible target image.

One or more of the following features may be included. Modifying the webpage may include modifying the webpage to render the advertisement overlay on top of the advertisement-compatible target image in response to activity by a user of the webpage. Processing one or more webpage images may include excluding from the one or more advertisement-compatible target images those webpage images that have a image size that is smaller than a defined minimum image size; and excluding from the one or more advertisement-compatible target images those webpage images that have an image size that is equal to a standard advertisement image size.

Analyzing an advertisement-compatible target image may include one or more of the following: extracting page-specific metadata from code associated with the webpage; extracting image-specific metadata from code associated with the advertisement-compatible target image; extracting image-specific metadata from a filename associated with the advertisement-compatible target image; and extracting user specific metadata associated with the user of the webpage. Analyzing an advertisement-compatible target image may include assigning one or more weighting scores to the advertisement-compatible target image, wherein each of the one or more weighting scores defines a level of association with each of the one or more advertisement categories.

Generating an advertisement overlay for the advertisement-compatible target image may include one or more of the following: defining an overlay type, wherein the advertisement overlay is generated in accordance with the defined overlay type; defining an overlay size; and defining an overlay position. The overlay type may be chosen from the group consisting of: a text only overlay; an image/banner overlay; a text and image overlay; a video overlay; an audio overlay; an audio/video overlay; a rich media interactive overlay; and a search overlay.

A publisher of the webpage may be provided with a revenue payment each time that an action is taken by the user of the webpage. The action taken by the user of the webpage may be chosen from the group consisting of: an automatic rendering action; a mouse over action; a clicking through action; and a product purchase.

In another implementation, a computing system includes at least one processor, and at least one memory architecture coupled with the at least one processor. A first software module is executed on the at least one processor and the at least one memory architecture. The first software module is configured to process one or more webpage images included within a webpage to identify one or more advertisement-compatible target images. A second software module is executed on the at least one processor and the at least one memory architecture. The second software module is configured to analyze an advertisement-compatible target image, chosen from the one or more advertisement-compatible target images, to associate the advertisement-compatible target image with one or more advertisement categories. A third software module is also executed on the at least one processor and the at least one memory architecture. The third software module is configured to generate an advertisement overlay for the advertisement-compatible target image. The advertisement overlay is associated with at least one of the one or more advertisement categories. A fourth software module is also executed on the at least one processor and the at least one memory architecture. The fourth software module is configured to modify the webpage to render the advertisement overlay on top of the advertisement-compatible target image.

One or more of the following features may be included. Modifying the webpage may include modifying the webpage to render the advertisement overlay on top of the advertisement-compatible target image in response to activity by a user of the webpage. Processing one or more webpage images may include excluding from the one or more advertisement-compatible target images those webpage images that have a image size that is smaller than a defined minimum image size; and excluding from the one or more advertisement-compatible target images those webpage images that have an image size that is equal to a standard advertisement image size.

Analyzing an advertisement-compatible target image may include one or more of the following: extracting page-specific metadata from code associated with the webpage; extracting image-specific metadata from code associated with the advertisement-compatible target image; extracting image-specific metadata from a filename associated with the advertisement-compatible target image; and extracting user specific metadata associated with the user of the webpage. Analyzing an advertisement-compatible target image may include assigning one or more weighting scores to the advertisement-compatible target image, wherein each of the one or more weighting scores defines a level of association with each of the one or more advertisement categories.

Generating an advertisement overlay for the advertisement-compatible target image may include one or more of the following: defining an overlay type, wherein the advertisement overlay is generated in accordance with the defined overlay type; defining an overlay size; and defining an overlay position. The overlay type may be chosen from the group consisting of: a text only overlay; an image/banner overlay; a text and image overlay; a video overlay; an audio overlay; an audio/video overlay; a rich media interactive overlay; and a search overlay.

A publisher of the webpage may be provided with a revenue payment each time that an action is taken by the user of the webpage. The action taken by the user of the webpage may be chosen from the group consisting of: an automatic rendering action; a mouse over action; a clicking through action; and a product purchase.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an advertising process coupled to a distributed computing network;

FIG. 2 is a flowchart of the advertising process of FIG. 1;

FIG. 3 is a diagrammatic view of a webpage;

FIG. 4 is a diagrammatic view of an advertisement overlay rendered by the advertising process of FIG. 1;

FIG. 5 is a diagrammatic view of an advertisement overlay rendered by the advertising process of FIG. 1;

FIG. 6 is a diagrammatic view of an advertisement overlay rendered by the advertising process of FIG. 1;

FIG. 7 is a diagrammatic view of an advertisement overlay rendered by the advertising process of FIG. 1;

FIG. 8 is a diagrammatic view of an advertisement overlay rendered by the advertising process of FIG. 1;

FIG. 9 is a diagrammatic view of an advertisement overlay rendered by the advertising process of FIG. 1;

FIG. 10A is a diagrammatic view of a display screen rendered by the advertising process of FIG. 1;

FIG. 10B is a diagrammatic view of a display screen rendered by the advertising process of FIG. 1;

FIG. 11A is a diagrammatic view of a display screen rendered by the advertising process of FIG. 1; and

FIG. 11B is a diagrammatic view of a display screen rendered by the advertising process of FIG. 1.

Like reference symbols in the various drawings indicate like elements.

### DETAILED DESCRIPTION OF THE PREFERRED EMBODIMENTS

### System Overview

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

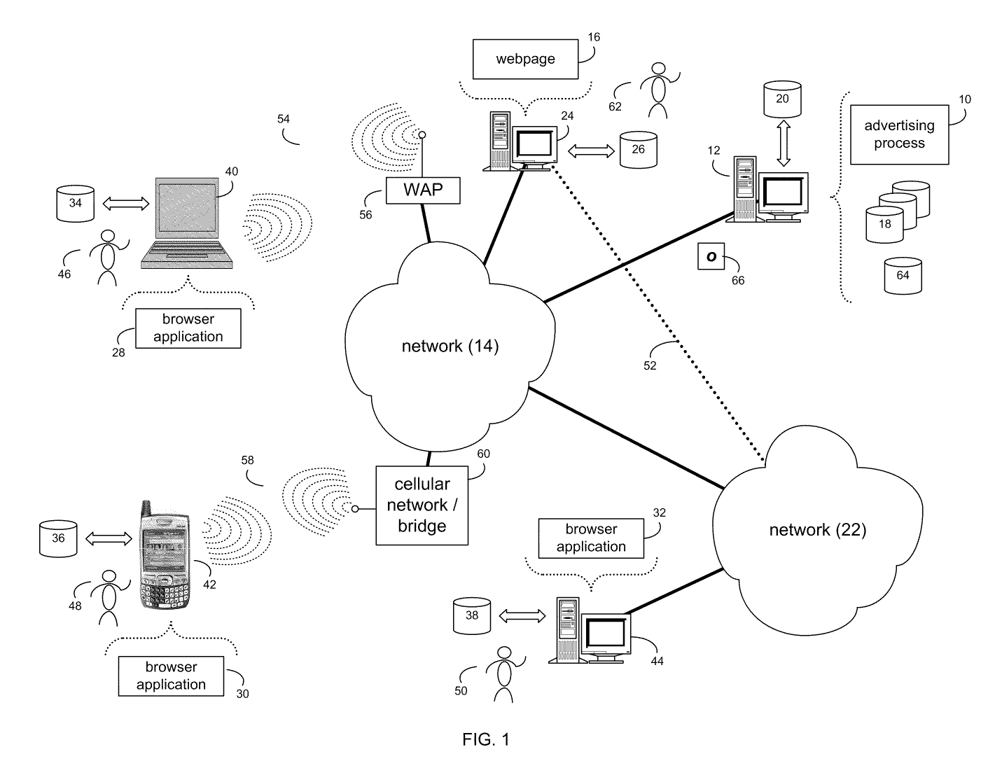

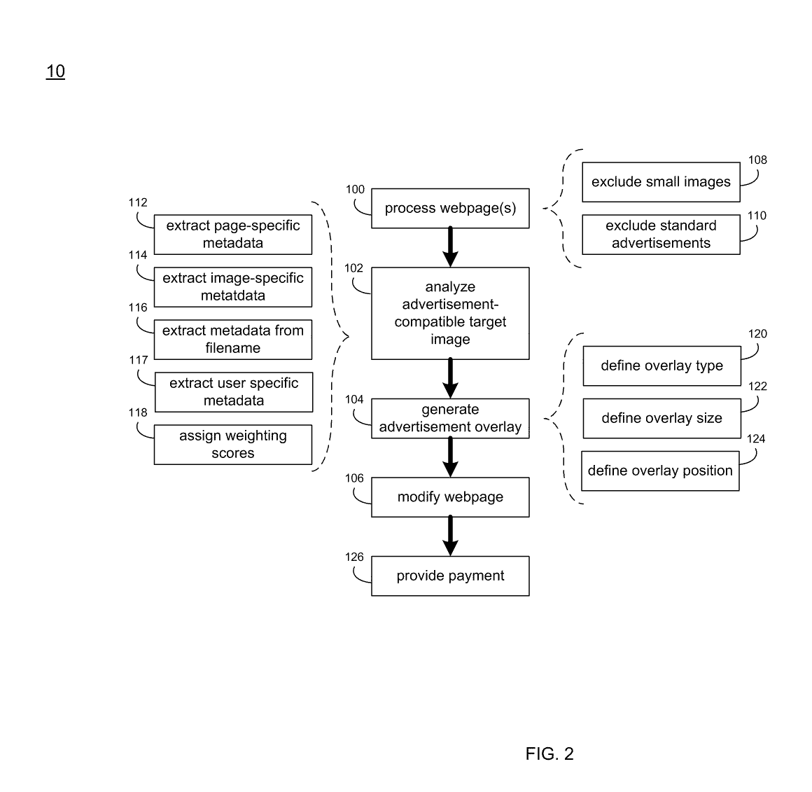

Referring to FIGS. 1 & 2, there is shown advertising process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, advertising process 10 may process 100 one or more webpage images included within a webpage 16 to identify one or more advertisement-compatible target images. An advertisement-compatible target image, chosen from the one or more advertisement-compatible target images, may be analyzed 102 to associate the advertisement-compatible target image with one or more advertisement categories 18. An advertisement overlay may be generated 104 for the advertisement-compatible target image. The advertisement overlay may be associated with at least one of advertisement categories 18. Webpage 16 may be modified 106 to render the advertisement overlay on top of the advertisement-compatible target image.

The instruction sets and subroutines of advertising process 10, which may be stored on storage device 20 coupled to server computer 12, may be executed by one or more processors (not shown) and one or more memory architectures (not shown) incorporated into server computer 12. Storage device 20 may include but is not limited to: a hard disk drive; a tape drive; an optical drive; a RAID array; a random access memory (RAM); and a read-only memory (ROM).

Server computer 12 may execute a web server application, examples of which may include but are not limited to: IBM WebSphere™, Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 22), examples of which may include but are not limited to: a local area network; a wide area network; or an intranet, for example.

Computer 24 may serve webpage 16, which may be stored on storage device 26 coupled to computer 24. Computer 24 may be a web server (or a series of servers) running a network operating system, examples of which may include but are not limited to: Microsoft Windows XP Server™; Novell Netware™; or Redhat Linux™, for example.

Computer 24 may execute a web server application, examples of which may include but are not limited to: IBM WebSphere™, Microsoft IIS™, Novell Webserver™, or Apache Webserver™, that allows for HTTP (i.e., HyperText Transfer Protocol) access to server computer 24 via network 14.

The instruction sets and subroutines of browser applications 28, 30, 32, which may be stored on storage devices 34, 36, 38 (respectively) coupled to client electronic devices 40, 42, 44 (respectively), may be executed by one or more processors (not shown) and one or more memory architectures (not shown) incorporated into client electronic devices 40, 42, 44 (respectively). Storage devices 34, 36, 38 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 40, 42, 44 may include, but are not limited to, laptop computer 40, personal digital assistant 42, personal computer 44, a server (not shown), a notebook computer (not shown), a data-enabled, cellular telephone (not shown), and a dedicated network device (not shown). Using browser applications 28, 30, 32, users 46, 48, 20 (respectively) may access webpage 16.

Users 46, 48, 50 may access webpage 16 directly through the device on which the browsing application (e.g., browsing applications 28, 30, 32) is executed, namely client electronic devices 40, 42, 44, for example. Users 46, 48, 50 may access webpage 16 directly through network 14 or through secondary network 22. Further, computer 24 (i.e., the computer that serves webpage 16) may be connected to network 14 through secondary network 18, as illustrated with link line 52 (shown in phantom).

The various client electronic devices may be directly or indirectly coupled to network 14 (or network 22). For example, personal computer 44 is shown directly coupled to network 22 via a hardwired network connection. Further, laptop computer 40 is shown wirelessly coupled to network 14 via wireless communication channel 54 established between laptop computer 40 and wireless access point (i.e., WAP) 56, which is shown directly coupled to network 14. WAP 56 may be, for example, an IEEE 802.11a, 802.11b, 802.11 g, 802.11n, Wi-Fi, and/or Bluetooth device that is capable of establishing wireless communication channel 54 between laptop computer 40 and WAP 56. Personal digital assistant 42 is shown wirelessly coupled to network 14 via wireless communication channel 58 established between personal digital assistant 42 and cellular network/bridge 60, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 40, 42, 44 may each execute an operating system, examples of which may include but are not limited to Microsoft Windows™, Microsoft Windows CE™, Redhat Linux™, or a custom operating system.

### The Advertising Process:

As stated above and as will be discussed below in greater detail, advertising process 10 may process 100 one or more webpage images included within a webpage 16 to identify one or more advertisement-compatible target images.

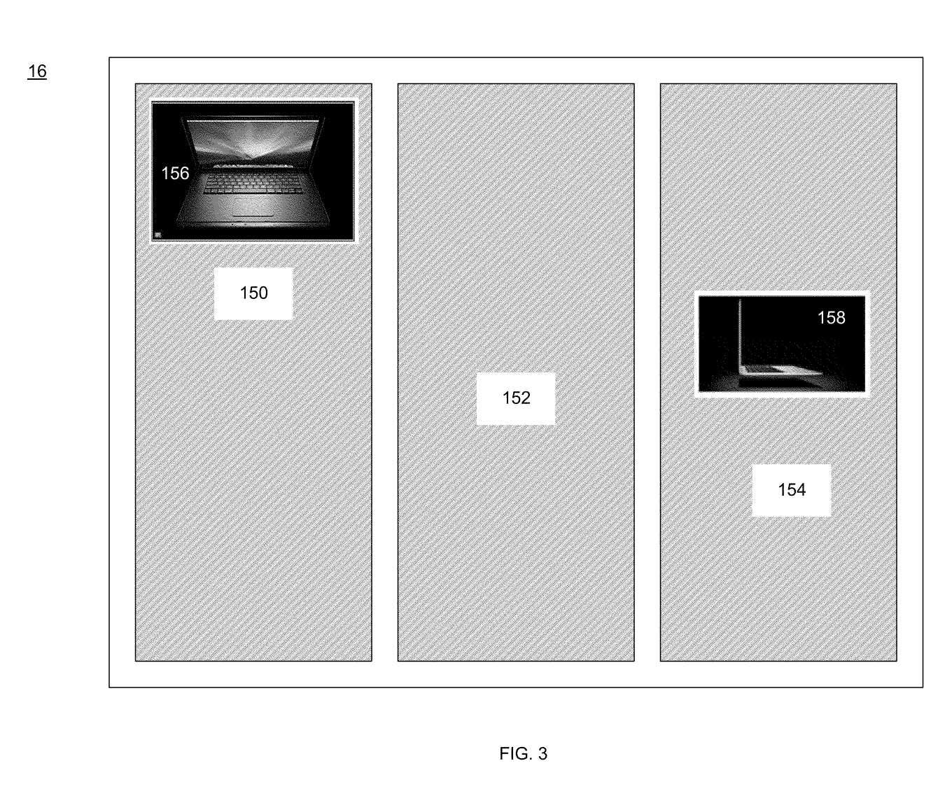

For example and referring also to FIG. 3, webpage 16 may include multiple components, such as text portions 150, 152, 154 and webpage images 156, 158. As discussed above, webpage 16 may be stored on storage device 20 and may be served by computer 24. Webpage 16 may be published/maintained/owned by publisher 62. Publisher 62 may represent an individual, a group of individuals, a company, a corporation or any other legal entity.

In order for advertisement process 10 to process 100 webpage images 156, 158 included within webpage 16 to identify one or more advertisement-compatible target images, publisher 62 may modify webpage 16 (e.g., modify the HTML code associated with webpage 16) to include a portion of code (e.g., HTML code) that initiates the processing 100 of webpage images 156, 158 when webpage 16 is served due to e.g., user 50 visiting webpage 16.

An example of such code added to/included within the code associated with webpage 16 is as follows:

<script src=“http://services.picadmedia.com/js/picad.js”
type=“text/javascript”></script>
<script type=“text/javascript”>
picadService.initialize( );
</script>

As an alternative to publisher 62 modifying webpage 16, publisher 62 may provide the necessary security information (e.g., user name/password) to advertising process 10 so that advertising process 10 may gain access to the code associated with webpage 16 and may automatically modify the code associated with webpage 16.

When advertising process 10 processes 100 the webpage images (e.g., webpage images 156, 158) included within webpage 16 to identify one or more advertisement-compatible target images, advertising process 10 may exclude 108 from the one or more advertisement-compatible target images those webpage images that have a image size that is smaller than a defined minimum image size. Additionally, advertising process 10 may exclude 110 from the one or more advertisement-compatible target images those webpage images that have an image size that is equal to a standard advertisement image size.

For example, if a webpage image is too small to support an advertisement overlay (e.g., smaller than 200×100 pixels), these webpage images may be excluded 108 by advertising process 100 from the list of advertisement-compatible target images (i.e., to avoid cramped advertisement overlays). Further, if a webpage image is a standard size for an advertisement (e.g., 720×90 pixels for a standard banner advertisement or 320×250 pixels for a standard web advertisement), these webpage images may be excluded 110 by advertising process 10 from the list of advertisement-compatible target images (i.e., to avoid placing an advertisement overlay on top of an advertisement image).

Assume for illustrative purposes that webpage image 156 is deemed to be an advertisement-compatible target image and that webpage image 158 is deemed to not be an advertisement-compatible target image (e.g., as the image is a 320×250 pixel standard web advertisement).

As discussed above, advertising process 10 may analyze 102 an advertisement-compatible target image (e.g., webpage image 156), chosen from the one or more advertisement-compatible target images, to associate the advertisement-compatible target image with one or more advertisement categories 18. For illustrative purposes, the total number of webpage images (e.g., webpage image 156, 158) included within webpage 16 is limited to two. However, it is understood that the quantity of images included within webpage 16 may greatly increase, as may the number of advertisement-compatible target images (which for illustrative purposes in this example is limited to one).

Continuing with the above-stated example, when analyzing 102 an advertisement-compatible target image (e.g., webpage image 156) to associate the advertisement-compatible target image with one or more advertisement categories 18, advertising process 10 may perform various functions/processes, examples of which may include but are not limited to: extracting 112 page-specific metadata from code associated with the webpage; extracting 114 image-specific metadata from code associated with the advertisement-compatible target image; and extracting 116 image-specific metadata from a filename associated with the advertisement-compatible target image. Additionally, advertising process 10 may extract 117 user specific metadata associated with a user of webpage 16. Examples of such user specific metadata may include but is not limited to: the IP address of the computer of the user of webpage 16 (which may be used to define the geographic location of the user and/or demographic information concerning the user).

Further, when analyzing 102 the advertisement-compatible target image (e.g., webpage image 156), one or more weighting scores may be assigned 118 to the advertisement-compatible target image (e.g., webpage image 156), such that each of the weighting scores defines a level of association with each of advertisement categories 18.

Continuing with the above-stated example, assume for illustrative purposes only that the code associated with webpage 16 includes page-specific metadata, such as keywords “laptops”, “computer”, “servers”, “processors”, and “network”. Accordingly, advertising process 10 may extract 112 this page-specific metadata from the code associated with webpage 16 and use this extracted page-specific metadata (in whole or in part) as a basis for assigning 120 the above-referenced weighting scores.

Further assume for illustrative purposes only that the code associated with webpage image 156 includes image-specific metadata, such as keywords “Apple” and “MacBook”. Accordingly, advertising process 10 may extract 114 this image-specific metadata from the code associated with webpage image 156 and use this extracted image-specific metadata (in whole or in part) as a basis for assigning 120 the above-referenced weighting scores.

Further still; assume for illustrative purposes only that the filename associated with webpage image 156 is “macbookpro.jpg”. Accordingly, advertising process 10 may extract 116 image-specific metadata (e.g., “MacBook Pro”) from the filename (e.g., “macbookpro.jpg”) associated with webpage image 156 and use this extracted image-specific metadata (in whole or in part) as a basis for assigning 118 the above-referenced weighting scores.

While the process of extracting 112, 114, 116 metadata (e.g., keywords) and associating the same with the advertisement-compatible target image (e.g., webpage image 156) is typically performed autonomously by advertising process 10, advertising process 10 may be configured to allow e.g., publisher 62 to add/modify the metadata (e.g., keywords) associated with the advertisement-compatible target image (e.g., webpage image 156).

Continuing with the above-stated example, the keywords/metadata extracted 112, 114, 116 may be used (in whole or in part) to assign 118 weighting scores to the advertisement-compatible target image (e.g., webpage image 156), such that each of the weighting scores defines a level of association with each of advertisement categories 118. For example, advertising process 10 may maintain associations database 64 that associates identified keywords with above-described advertisement categories 18. For example, keywords such as “sailboats”, “scuba diving”, and “surfing” may be associated with categories such as “vacation” and “travel”. Further, keywords such as “computer”, “server” and “network” may be associated with categories such as “technology”, “computers”, and “IT”. Additionally, when a keyword (e.g., “BMW”) is associated with a plurality of categories (e.g., “BMW”, “European cars”, and “cars”), the category's weighting score may reflect the proximity of the keyword's relationship to those categories. For example, keyword “BMW” may be highly related to category “BMW”, slightly less related to category “European cars”, and even less related to category “cars”.

Continuing with the above-stated example in which the keywords “laptops”; “computer”; “servers”; “processors”; “network”; “Apple”; “MacBook”; and “MacBook Pro” were extracted 112, 114, 116, assume that advertising process 10 utilizes associations database 64 and assigns 118 the following three categories/weighting scores, namely: “technology” (with a weighting score of 93), “computers” (with a weighting score of 89), and “IT” (with a weighting score of 77).

As is understood, these weighting scores may be defined in various ways, such as: being based upon an algorithm; being based upon business decisions (e.g., one category clients pay more than another category clients); being based upon available options (e.g., there are no “BMW” category clients but there are “European Car” category clients); and being based upon the geographic location of the user (e.g., users in the northeast are more interested in Caribbean travel than users in Florida), for example.

While the process of assigning 118 categories/weighting scores with the advertisement-compatible target image (e.g., webpage image 156) is typically performed autonomously by advertising process 10, advertising process 10 may be configured to allow e.g., publisher 62 to modify the categories/weighting scores assigned 118 to the advertisement-compatible target image (e.g., webpage image 156).

Accordingly, as the appropriate categories have now been assigned 118, advertising process 10 may utilize these assigned categories/weighting scores in various ways to define the types of advertisements that may be associated with these images (in this case, webpage image 156). For example, all of the advertisements associated with webpage image 156 may be associated with the category having the highest weighting score (which in this example is category “technology”). Alternatively, the advertisements associated with webpage image 156 may be associated in accordance with the individual weighting scores of each category. For example, if the weighting scores for three categories were 90, 80 and 70 (respectively), the advertisements associated with webpage image 156 may follow a similar pro rata distribution. For example, for each 240 advertisements (i.e., the sum of 90+80+70) provided by advertisement process 10, 90 of the 240 advertisements may be associated with Category 1, 80 of the 240 advertisements may be associated with Category 2, and 70 of the 240 advertisements may be associated with Category 3.

Continuing with the above-stated example, assume for illustrative purposes that all of the advertisements associated with webpage image 156 are chosen from the category “Technology” (i.e., the category having the highest score of 93). Accordingly, all of the advertisement overlays will concern products associated with the category “Technology”, such as those offered by e.g., Apple™, Microsoft™, Hewlett Packard™, and Dell™.

As discussed above, advertising process 10 may generate 104 an advertisement overlay (e.g., overlay 66) for the advertisement-compatible target image (namely webpage image 156). For example, the advertisement overlays may be generated 104 using JavaScript. Advertisement overlay 66 may be associated with at least one of advertisement categories 18 (in this case and for this example, category “Technology”).

Generating 104 an advertisement overlay (e.g., advertisement overlay 66) for the advertisement-compatible target image (e.g., webpage image 156) may include one or more of the following: defining 120 an overlay type (wherein the advertisement overlay is generated in accordance with the defined overlay type); defining 122 an overlay size; and defining 124 an overlay position.

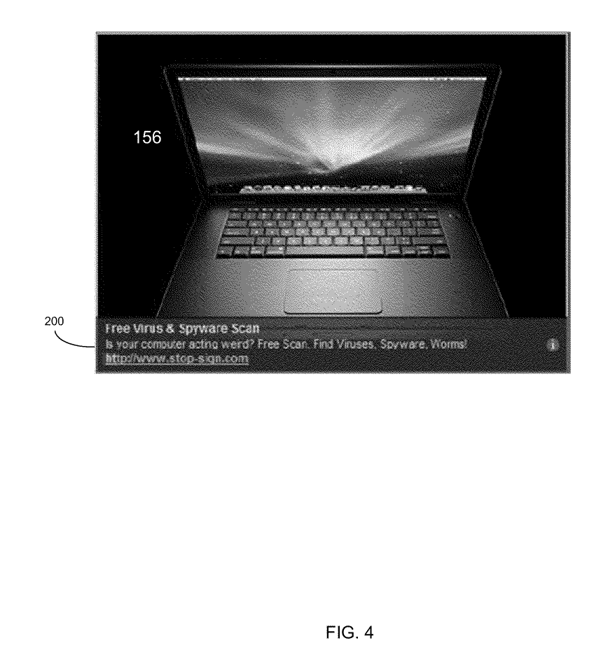

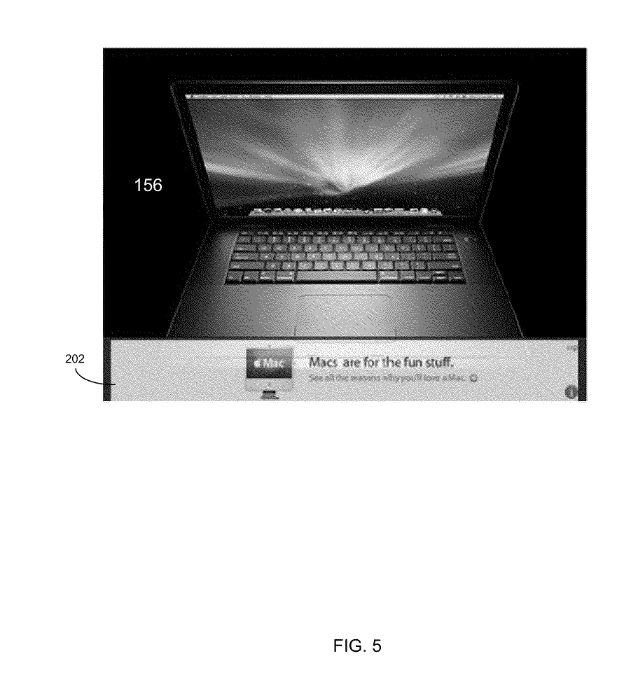

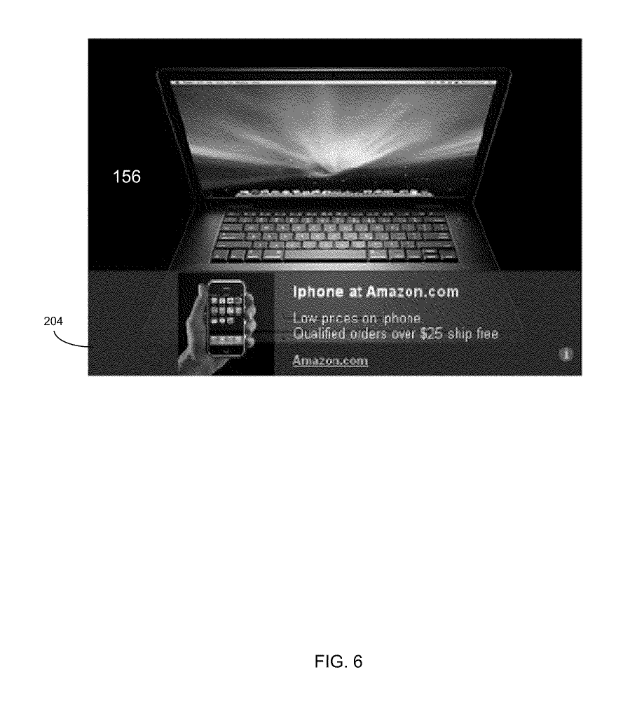

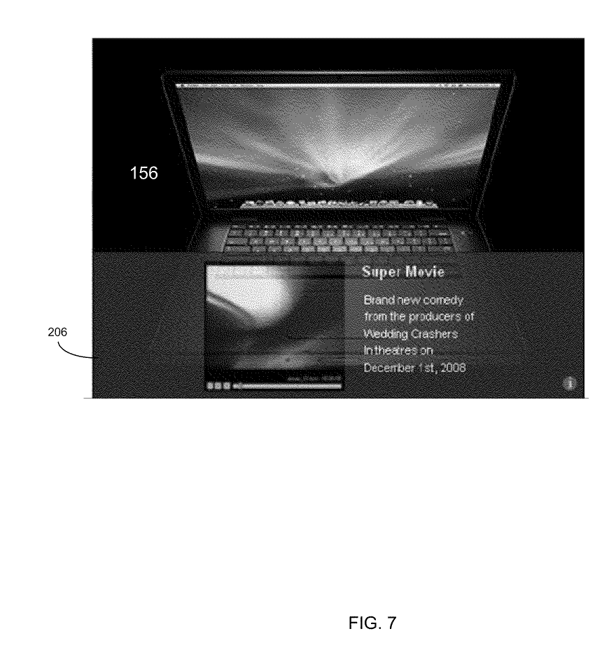

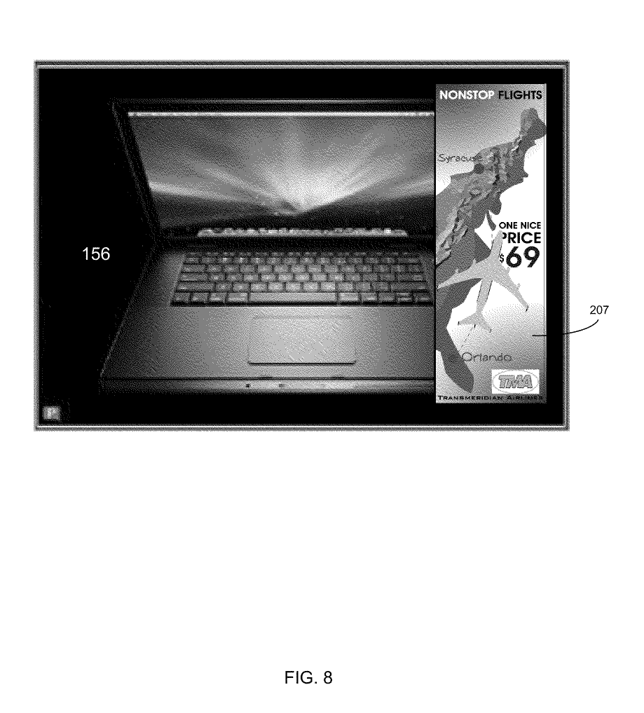

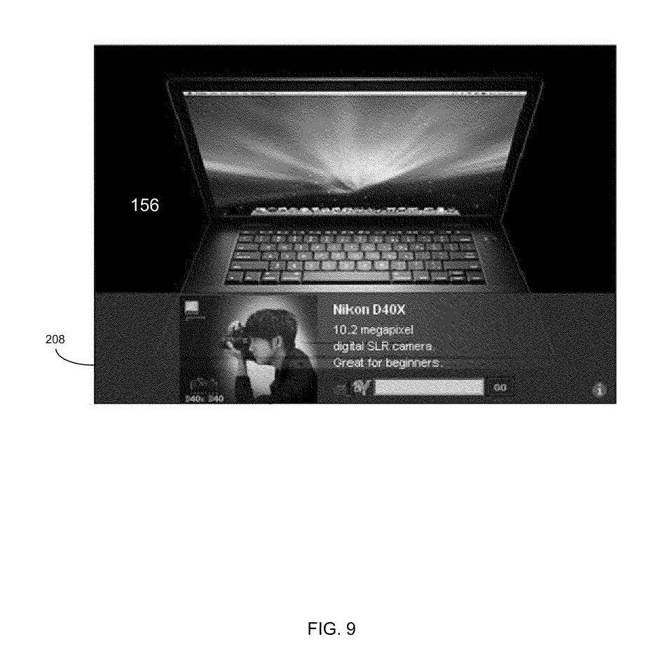

When defining 120 the overlay type, the overlay type may be chosen from the group consisting of: a text only overlay (see text-only overlay 200, FIG. 4); an image/banner overlay (see image/banner overlay 202, FIG. 5); a text and image overlay (see text and image overlay 204, FIG. 6); a video overlay (see video overlay 206, FIG. 7); an audio overlay (not shown); an audio/video overlay (not shown); a rich media interactive overlay (see rich media overlay 207, FIG. 8); and a search overlay (see search overlay 208, FIG. 9).

The specific type of advertisement overlay utilized with a webpage image may be automatically defined by advertising process 10. This decision may be governed by the budget/size of the advertising campaign, bandwidth considerations, etc. Alternatively, advertising process 10 may be configured to allow the publisher of the webpage (in this particular example, publisher 62) to provide preferences or make the decision concerning the type of advertisement overlay utilized for a specific webpage image (e.g., webpage image 156).

When advertising process 10 defines 122 an overlay size for (in this example) advertisement overlay 66, the size of advertisement overlay 66 is typically identical (or nearly identical) to the size of the associated webpage image (e.g., webpage image 156). For example, assuming that webpage image 156 is 300×200 pixels, advertisement overlay 66 may also be 300×200 pixels.

When advertising process 10 defines 124 an overlay position for (in this example) advertisement overlay 66, the position of advertisement overlay 66 is typically identical (or nearly identical) to the position of the associated webpage image (e.g., webpage image 156), thus allowing advertisement overlay 66 to be properly positioned on top of webpage image 156.

As discussed above, advertising process 10 may modify 106 webpage 16 to render the advertisement overlay (e.g., advertisement overlay 66) on top of the advertisement-compatible target image (e.g., webpage image 156). For example, advertisement overlay (e.g., advertisement overlay 66) may be rendered on top of the advertisement-compatible target image (e.g., webpage image 156) in response to activity by a user (e.g., user 50) of webpage 16. Accordingly, the code (e.g., HTML code) associated with webpage 16 generically (and webpage image 156 specifically) may be modified so that whenever a visitor (e.g., user 60) of webpage 16 acts in a certain fashion (to be discussed below), advertisement overlay 66 (in this example) may be rendered on top of webpage image 156. Accordingly, webpage image 156 does not need to be modified, as advertisement overlay 66 is merely rendered on top of webpage image 156. Examples of the activity taken by the user that may result in advertisement overlay 66 being rendered on top of webpage image 156 may include but are not limited to: a mouse-over action of webpage image 156, or a clicking action (left or right click) on webpage image 156.

Alternatively, the code (e.g., HTML code) associated with webpage 16 generically (and webpage image 156 specifically) may be modified so that the advertisement overlay (e.g., advertisement overlay 66) may be rendered on top of the advertisement-compatible target image (e.g., webpage image 156) whenever webpage 16 is loaded. Therefore, the rendering of the advertisement overlay (e.g., advertisement overlay 66) would not require that any activity be performed by the user, as the advertisement overlays (e.g., advertisement overlay 66) would be automatically rendered upon the loading of webpage 16.

Advertising process 10 may provide 126 a publisher (e.g., publisher 62) of the webpage (e.g., webpage 16) with a revenue payment each time that an action is taken by the user (e.g., user 5) of webpage 16. Examples of the action taken by user 50 of webpage 16 may include but are not limited to: an automatic rendering action; a mouse over action; a clicking through action; and a product purchase.

For example and as discussed above, each time that user 50 positions their pointer (not shown) over advertisement overlay 66, advertising process 10 may render advertisement overlay 66 on top of webpage image 156. Accordingly, each time that advertisement overlay 66 is rendered, advertising process 10 may provide 126 publisher 62 with a revenue payment. Alternatively/additionally, in the event that user 50 clicks on advertisement overlay 66 rendered on top of webpage image 156, user 50 may be directed to a webpage (e.g., www.apple.com) that advertises a product/service associated with the chosen category (e.g., Category “Technology”) and advertising process 10 may provide 126 publisher 62 with a revenue payment. Alternatively/additionally, in the event that user 50 clicks on advertisement overlay 66 rendered on top of webpage image 156, is directed to a webpage (e.g., www.apple.com) that advertises a product/service associated with the chosen category (e.g., Category “Technology”) and purchases such a product/service, advertising process 10 may provide 126 publisher 62 with a revenue payment. Alternatively/additionally, each time that webpage 16 is loaded, advertisement overlay 66 may be automatically rendered on top of webpage image 156 and advertising process 10 may provide 126 publisher 62 with a revenue payment.

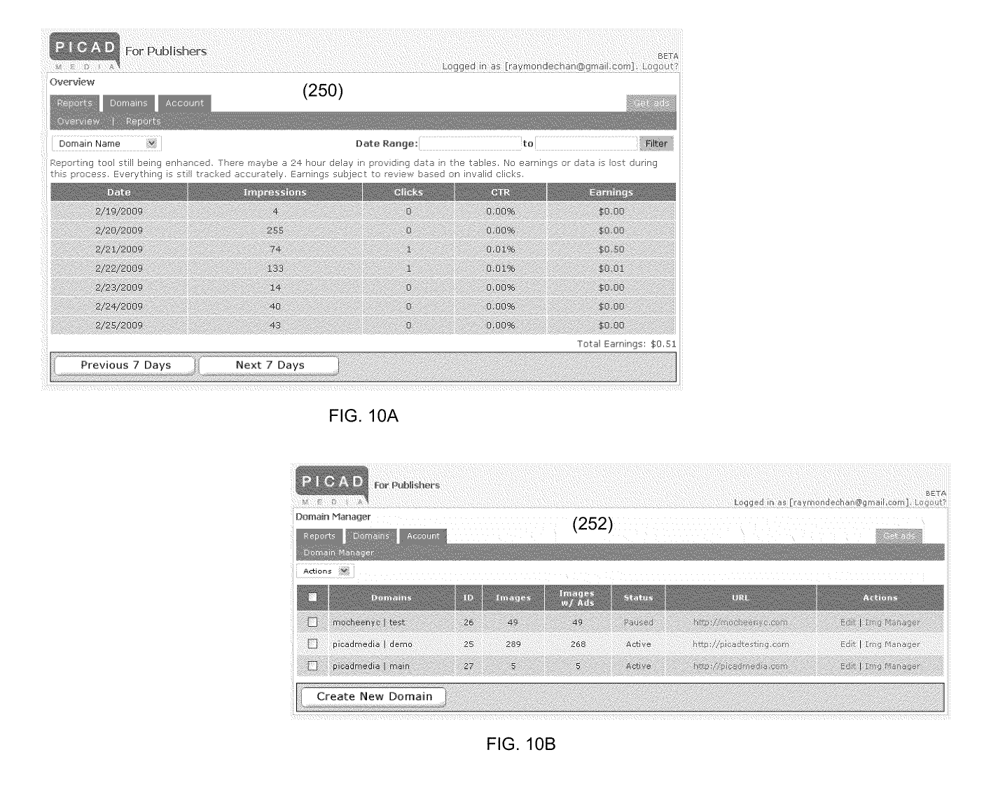

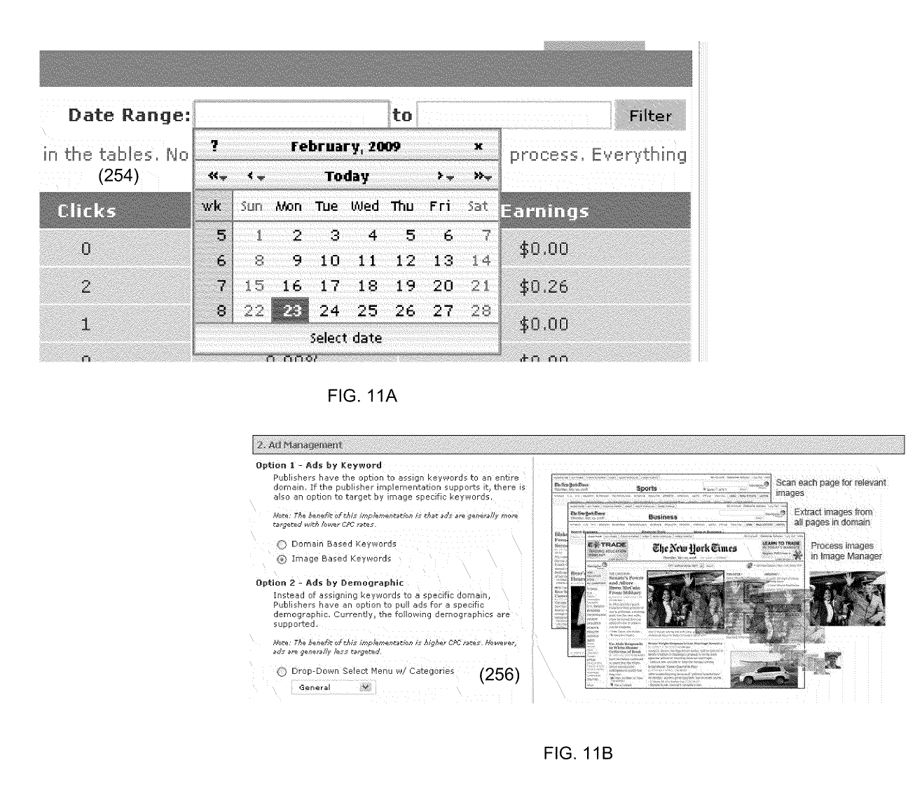

Referring also to FIGS. 10A, 10B, 11A & 11B, advertising process 10 may be configured to allow the publisher to at least partially control the manner in which advertising process 10 processes e.g., webpage 16 and to obtain statistics concerning their website/webpage. For example, advertising process 10 may be configured to allow e.g., publisher 62 to securely access server computer 12 and log into a control panel application (as illustrated in exemplary control panel application screenshots 250, 252, 254, 256) that allows publisher 62 to perform a variety of functions.

For example and as discussed above, while the process of extracting 112, 114, 116 metadata (e.g., keywords) and associating the same with the advertisement-compatible target image (e.g., webpage image 156) is typically performed autonomously by advertising process 10, advertising process 10 may be configured to allow e.g., publisher 62 to add/modify the metadata (e.g., keywords) associated with the advertisement-compatible target image (e.g., webpage image 156). Accordingly, the above-described control panel application may allow e.g., publisher 62 to add/modify the metadata (e.g., keywords) associated with the advertisement-compatible target image.

Further and as discussed above, while the process of assigning 118 categories/weighting scores with the advertisement-compatible target image (e.g., webpage image 156) is typically performed autonomously by advertising process 10, advertising process 10 may be configured to allow e.g., publisher 62 to modify the categories/weighting scores assigned 118 to advertisement-compatible target image (e.g., webpage image 156). Accordingly, the above-described control panel application may allow e.g., publisher 62 to modify the categories/weighting scores assigned 118 to the advertisement-compatible target image.

Further, the above-described control panel application may allow a publisher to manage multiple domains in the event that the publisher is utilizing advertising service 10 on a plurality of websites (and thus has to manage a plurality of domains). Further, the above-described control panel application may be configured to allow publisher 62 to obtain image-level statistics, page-level statistics, and/or domain-level statistics. For example, the above-described control panel application may allow publisher 62 to determine the amount of revenue generated by a specific webpage image, a specific webpage, and/or a specific domain.

For example, assume for illustrative purposes that webpage 16 includes twenty webpage images. Further, assume for illustrative purposes that three of the twenty webpage images produce 80% of the total revenue generated by webpage 16. Accordingly, through the use of the above-described control panel application, publisher 62 may determine the three webpage images that are producing the lion's share (e.g., 80%) of the revenue and e.g., make adjustments to and/or replace one or more of the other seventeen webpage images included within webpage 16 to possibly increase the revenue produced by the same.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

A number of implementations have been described. Nevertheless, it will be understood that various modifications may be made. Accordingly, other implementations are within the scope of the following claims.

What is claimed is:

1. A computer-implemented method comprising:
processing one or more webpage images included within a webpage to identify one or more advertisement-compatible target images;
analyzing an advertisement-compatible target image, chosen from the one or more advertisement-compatible target images, to associate the advertisement-compatible target image with one or more advertisement categories;
generating an advertisement overlay for the advertisement-compatible target image, wherein the advertisement overlay is associated with at least one of the one or more advertisement categories; and
modifying the webpage to render the advertisement overlay on top of the advertisement-compatible target image.

2. The computer-implemented method of claim 1 wherein modifying the webpage includes:
modifying the webpage to render the advertisement overlay on top of the advertisement-compatible target image in response to activity by a user of the webpage.

3. The computer-implemented method of claim 1 wherein processing one or more webpage images includes:
excluding from the one or more advertisement-compatible target images those webpage images that have a image size that is smaller than a defined minimum image size; and
excluding from the one or more advertisement-compatible target images those webpage images that have an image size that is equal to a standard advertisement image size.

4. The computer-implemented method of claim 1 wherein analyzing an advertisement-compatible target image includes one or more of the following:
extracting page-specific metadata from code associated with the webpage;
extracting image-specific metadata from code associated with the advertisement-compatible target image;
extracting image-specific metadata from a filename associated with the advertisement-compatible target image; and
extracting user specific metadata associated with the user of the webpage

5. The computer-implemented method of claim 1 wherein analyzing an advertisement-compatible target image includes:
assigning one or more weighting scores to the advertisement-compatible target image, wherein each of the one or more weighting scores defines a level of association with each of the one or more advertisement categories.

6. The computer-implemented method of claim 1 wherein generating an advertisement overlay for the advertisement-compatible target image includes one or more of the following:
defining an overlay type, wherein the advertisement overlay is generated in accordance with the defined overlay type;
defining an overlay size; and
defining an overlay position.

7. The computer-implemented method of claim 6 wherein the overlay type is chosen from the group consisting of:
a text only overlay;
an image/banner overlay;
a text and image overlay;
a video overlay;
an audio overlay;
an audio/video overlay;
a rich media interactive overlay; and
a search overlay.

8. The computer-implemented method of claim 1 further comprising:
providing a publisher of the webpage with a revenue payment each time that an action is taken by the user of the webpage.

9. The computer-implemented method of claim 8 wherein the action is taken by the user of the webpage is chosen from the group consisting of:
an automatic rendering action;
a mouse over action;
a clicking through action; and
a product purchase.

10. A computer program product residing on a computer readable medium having a plurality of instructions stored thereon that, when executed by a processor, cause the processor to perform operations comprising:
processing one or more webpage images included within a webpage to identify one or more advertisement-compatible target images;
analyzing an advertisement-compatible target image, chosen from the one or more advertisement-compatible target images, to associate the advertisement-compatible target image with one or more advertisement categories;
generating an advertisement overlay for the advertisement-compatible target image, wherein the advertisement overlay is associated with at least one of the one or more advertisement categories; and
modifying the webpage to render the advertisement overlay on top of the advertisement-compatible target image.

11. The computer program product of claim 10 wherein the instructions for modifying the webpage includes instructions for:
modifying the webpage to render the advertisement overlay on top of the advertisement-compatible target image in response to activity by a user of the webpage.

12. The computer program product of claim 10 wherein the instructions for processing one or more webpage images include instructions for:
excluding from the one or more advertisement-compatible target images those webpage images that have a image size that is smaller than a defined minimum image size; and
excluding from the one or more advertisement-compatible target images those webpage images that have an image size that is equal to a standard advertisement image size.

13. The computer program product of claim 10 wherein the instructions for analyzing an advertisement-compatible target image include instructions for one or more of the following:
extracting page-specific metadata from code associated with the webpage;
extracting image-specific metadata from code associated with the advertisement-compatible target image;
extracting image-specific metadata from a filename associated with the advertisement-compatible target image; and
extracting user specific metadata associated with the user of the webpage.

14. The computer program product of claim 10 wherein the instructions for analyzing an advertisement-compatible target image include instructions for:
assigning one or more weighting scores to the advertisement-compatible target image, wherein each of the one or more weighting scores defines a level of association with each of the one or more advertisement categories.

15. The computer program product of claim 10 wherein the instructions for generating an advertisement overlay for the advertisement-compatible target image include instructions for one or more of the following:
defining an overlay type, wherein the advertisement overlay is generated in accordance with the defined overlay type;
defining an overlay size; and
defining an overlay position.

16. The computer program product of claim 15 wherein the overlay type is chosen from the group consisting of:
a text only overlay;
an image/banner overlay;
a text and image overlay;
a video overlay;
an audio overlay;
an audio/video overlay;
a rich media interactive overlay; and
a search overlay.

17. The computer program product of claim 10 further comprising instructions for:
providing a publisher of the webpage with a revenue payment each time that an action is taken by the user of the webpage.

18. The computer program product of claim 17 wherein the action is taken by the user of the webpage is chosen from the group consisting of:
an automatic rendering action;
a mouse over action;
a clicking through action; and
a product purchase.

19. A computing system comprising:
at least one processor;
at least one memory architecture coupled with the at least one processor;
a first software module executed on the at least one processor and the at least one memory architecture, wherein the first software module is configured to process one or more webpage images included within a webpage to identify one or more advertisement-compatible target images;
a second software module executed on the at least one processor and the at least one memory architecture, wherein the second software module is configured to analyze an advertisement-compatible target image, chosen from the one or more advertisement-compatible target images, to associate the advertisement-compatible target image with one or more advertisement categories;
a third software module executed on the at least one processor and the at least one memory architecture, wherein the third software module is configured to generate an advertisement overlay for the advertisement-compatible target image, wherein the advertisement overlay is associated with at least one of the one or more advertisement categories; and
a fourth software module executed on the at least one processor and the at least one memory architecture, wherein the fourth software module is configured to modify the webpage to render the advertisement overlay on top of the advertisement-compatible target image.

20. The computing system of claim 19 wherein modifying the webpage includes:
modifying the webpage to render the advertisement overlay on top of the advertisement-compatible target image in response to activity by a user of the webpage.

21. The computing system of claim 19 wherein processing one or more webpage images includes:
excluding from the one or more advertisement-compatible target images those webpage images that have a image size that is smaller than a defined minimum image size; and
excluding from the one or more advertisement-compatible target images those webpage images that have an image size that is equal to a standard advertisement image size.

22. The computing system of claim 19 wherein analyzing an advertisement-compatible target image includes one or more of the following:
extracting page-specific metadata from code associated with the webpage;
extracting image-specific metadata from code associated with the advertisement-compatible target image;
extracting image-specific metadata from a filename associated with the advertisement-compatible target image; and
extracting user specific metadata associated with the user of the webpage.

23. The computing system of claim 19 wherein analyzing an advertisement-compatible target image includes:
assigning one or more weighting scores to the advertisement-compatible target image, wherein each of the one or more weighting scores defines a level of association with each of the one or more advertisement categories.

24. The computing system of claim 19 wherein generating an advertisement overlay for the advertisement-compatible target image includes one or more of the following:
defining an overlay type, wherein the advertisement overlay is generated in accordance with the defined overlay type;
defining an overlay size; and
defining an overlay position.

25. The computing system of claim 24 wherein the overlay type is chosen from the group consisting of:
a text only overlay;
an image/banner overlay;
a text and image overlay;
a video overlay;
an audio overlay;
an audio/video overlay;
a rich media interactive overlay; and
a search overlay.

26. The computing system of claim 19 further comprising a fifth software module executed on the at least one processor and the at least one memory architecture, wherein the fifth software module is configured to:
providing a publisher of the webpage with a revenue payment each time that an action is taken by the user of the webpage.

27. The computing system of claim 26 wherein the action is taken by the user of the webpage is chosen from the group consisting of:
an automatic rendering action;
a mouse over action;
a clicking through action; and
a product purchase.
